(19) United States
(12) Patent Application Publication
(10) Pub. No.: US 2012/0190763 A1
(43) Pub. Date: Jul. 26, 2012

(54) INSULATING CAVITIES IN BUILT STRUCTURES

(75) Inventors: Rene Jansen, Tilburg (NL); Dick Bos, Veendam (NL)

(73) Assignee: BASF SE, Ludwigshafen (DE)

(21) Appl. No.: 13/357,844

(22) Filed: Jan. 25, 2012

Related U.S. Application Data
(60) Provisional application No. 61/436,223, filed on Jan. 26, 2011.

(51) Int. Cl. C08J 9/00

(52) U.S. Cl. 521/131; 521/170

(57) ABSTRACT

The invention provides a process for insulating a cavity in a built structure with a polyurethane rigid foam, by reaction of
a) polyisocyanates with
b) compounds having at least two isocyanate-reactive hydrogen atoms in the presence of
c) blowing agents, wherein the reaction takes place in the cavity to be insulated, wherein the blowing agent c) comprises at least one blowing agent ci) which only develops its blowing effect at the stage of the reaction of a) with b), and a blowing agent cii) which has a boiling point which is below the temperature at which the components a) and b) are mixed.

The present invention relates to a process for thermally insulating built structures using polyurethane rigid foams.

Polyurethane foams are widely used in building construction. It is known, for instance, to surround windows and doors in built structures with 1-component foam. This type of foam, which is commonly known and described in DE 19858104 for example, typically comprises prepolymers filled into pressurized containers together with blowing agents. On depressurization, the prepolymer is forced out of the can and frothed up by the blowing agent. It is cured by reaction of the isocyanate groups in the prepolymer with atmospheric humidity.

It is further known to fill cavities in masonry with polyurethane rigid foams. Cavities in cavity blocks can be filled with rigid foam. It is also known to fill double wythe masonry with polyurethane rigid foam.

To keep the pressure in the masonry at a low level, the foams are typically of the open-cell type. To improve thermal insulation, it would be advantageous to use closed-cell foams, since these have a lower thermal conductivity.

A further problem with the insulation of double wythe masonry is that liquid reaction mixture can escape through leaky places in the masonry and soil the masonry in the form of a resulting foam.

It is an object of the present invention to provide a simple and clean process for insulating masonry wherein particularly the soiling of the outside walls is prevented and wherein a closed-cell foam can be used.

We have found that this object is achieved when the foams are produced using at least two blowing agents, at least one of which has a boiling point which is below the processing temperature and at least one of which only develops its blowing effect at the stage of the polyurethane reaction.

The present invention accordingly provides a process for insulating a cavity in a built structure, preferably masonry and more particularly double wythe masonry, with a polyurethane rigid foam, by reaction of

a) polyisocyanates with

b) compounds having at least two isocyanate-reactive hydrogen atoms in the presence of

c) blowing agents, wherein the reaction takes place in the cavity to be insulated, wherein the blowing agent c) comprises at least one blowing agent ci) which only develops its blowing effect at the stage of the reaction of a) with b), and a blowing agent cii) which has a boiling point which is below the temperature at which the components a) and b) are mixed.

The present invention further provides built structures comprising regions having a polyurethane rigid foam present therein, wherein the polyurethane rigid foam is of the closed-cell type.

The present invention further provides built structures comprising regions having a polyurethane rigid foam present therein, wherein the polyurethane rigid foam is of the closed-cell type and was introduced into the built structures by the process of the present invention.

By closed-cell is meant that the proportion of closed cells, when determined to DIN ISO 4590, is at least 90%.

The blowing agent ci) may be a chemical blowing agent. Water is preferably used as chemical blowing agent ci). In this embodiment, water is preferably used in an amount of above 0% by weight and more preferably above 0.5% by weight and up to 3% by weight, based on the component b).

The blowing agent ci) may also be a physical blowing agent, more particularly an optionally halogenated hydrocarbon. When a physical blowing agent is used as blowing agent ci), it is preferably selected from the group comprising hydrocarbons and halogenated hydrocarbons. Preference is given to saturated hydrocarbons, hereinafter also referred to as alkanes, and olefinically unsaturated hydrocarbons, hereinafter also referred to as alkenes.

For safety reasons, it is preferable to use halogenated alkanes and for ecological reasons it is preferable to use halogenated alkanes that still comprise at least one hydrogen atom in the molecule.

Blowing agents of this type are common knowledge and have been extensively described. Examples thereof are 1,1,1,3,3-pentafluoropropane (HFC-245fa), HCl2C-CF2 (HFCKW 123), Cl2FC-CH3 (HFCKW 141b).

It is further possible to use mixtures of 365fa and HFC 227 (1,1,1,3,3-pentafluorobutane and 1,1,1,2,3,3,3-heptafluoropropane). These mixtures are available for example from Solvay as Solkane® 365/227. The mixing ratios here of 365 to 227 are preferably in the range between 87:13 and 93:7.

The physical blowing agents ci) are preferably used in an amount of above 0% to 20% by weight, based on the component b).

One embodiment of the process according to the present invention utilizes a mixture of at least one physical and at least one chemical blowing agent as blowing agent ci). Typically, the mixture concerned here is of water and at least one halogenated hydrocarbon. In this embodiment it is again preferable to use water in an amount of above 0% by weight and more preferably above 0.5% by weight and up to 3% by weight. In this embodiment the physical blowing agents are again preferably used in an amount of above 0% to 20% by weight, based on the component b).

The exact amount of blowing agent depends on the target density of the foams.

The blowing agent cii) is typically a physical blowing agent. Halogenated hydrocarbons are preferably concerned.

The blowing agents cii) preferably have a boiling point of below 20° C. and more preferably below 0° C.

More particularly, the blowing agent cii) is selected from the group comprising 1,1,1,2-tetra-fluoroethane (134a), the hydrofluoroolefin HFO-1234ze or mixtures thereof, of which 1,1,1,2-tetrafluoroethane has the greatest industrial importance.

These blowing agents vaporize on exit from the metering device and thereby froth up the liquid reaction mixture before the onset of the reaction of components a) and b).

The blowing agent cii) is admixed to the reaction mixture—preferably immediately before or preferably during the mixing of components a) and b). Preferably it is added from a separate tank of at least one of the reaction components a) or b), preferably a), into the pipework of the foaming apparatus, preferably into the feed line to the mixing head, for example via a static mixer. It is also possible to dose the blowing agent cii) directly into the mixing head. The blowing agent cii) is preferably used at least in an amount of above 0% and more preferably above 0.5% by weight. The maximum amount is 12% by weight and preferably 10% by weight, both based on component b).

The blowing agent ci) is present in at least one of components a) and b) before the mixing of said components a) and b). Usually, the blowing agent ci) is added to component b). This is typically done at the blending stage of the polyurethane systems. Owing to the boiling temperatures of the blowing agents ci) being above room temperature, the mixtures formed from the components and the blowing agents are stable in storage.

The liquid reaction mixture is introduced into the cavities by the pour foam technique as known to be practiced for applications in building construction. The liquid reaction mixture is for example introduced into the cavities using a pouring device for the insulation of cavity blocks or flat roofs described in Kunststoffhandbuch, volume 7, Polyurethanes, 3rd edition, 1993, Carl Hanser Verlag Munich Vienna, pages 331 to 335.

The blowing agent cii) causes the reaction mixture emerging from the mixing device to froth up. As a result, the viscosity of the emerging mixture increases substantially. This prevents any egress of the mixture from the cavities and hence any soiling of the outside walls. In addition, this method of operation reduces the pressure buildup during foaming.

The frothing effect is sufficient to result in the formation of a foam which fills out a large proportion of the cavities without any significant pressure buildup taking place. The blowing agent ci) adjusts the foam to the target density. Again no significant pressure buildup takes place here. Curing takes place by the reaction of components a) and b).

Components used for producing the foam will now be more particularly described:

The organic polyisocyanate a) may be any known organic di- and polyisocyanate and preferably is an aromatic polyfunctional isocyanate.

Specific examples are 2,4- and 2,6-tolylene diisocyanate (TDI) and the corresponding isomeric mixtures, 4,4′-, 2,4′- and 2,2′-diphenylmethane diisocyanate (MDI) and the corresponding isomeric mixtures, mixtures of 4,4′- and 2,4′-diphenylmethane diisocyanates, polyphenyl polymethylene polyisocyanates, mixtures of 4,4′-, 2,4′- and 2,2′-diphenylmethane diisocyanates and polyphenyl polymethylene polyisocyanates (crude MDI) and mixtures of crude MDI and tolylene diisocyanates. The organic di- and polyisocyanates can be used singly or in the form of mixtures.

So-called modified polyfunctional isocyanates, i.e., products obtained by chemical reaction of organic di- and/or polyisocyanates, are frequently also used. Examples are di- and/or polyisocyanates comprising uretdione, carbamate, isocyanurate, carbodiimide, allophanate and/or urethane groups. Modified polyisocyanates may optionally be mixed with one another or with unmodified organic polyisocyanates such as, for example, 2,4′-, 4,4′-diphenylmethane diisocyanate, crude MDI, 2,4- and/or 2,6-tolylene diisocyanate.

Reaction products of polyfunctional isocyanates with polyfunctional polyols, and also their mixtures with other di- and polyisocyanates, can also be used.

One organic polyisocyanate which will prove particularly advantageous is crude MDI, especially with an NCO content of 29% to 33% by weight and a 25° C. viscosity in the range from 150 to 1000 mPas.

The compounds having at least two isocyanate-reactive hydrogen atoms comprise at least two reactive groups, preferably OH groups, and are more particularly polyether alcohols and/or polyester alcohols having OH numbers in the range from 25 to 2000 mg KOH/g.

The polyester alcohols used are usually obtained by condensation of polyfunctional alcohols, preferably diols, having 2 to 12 carbon atoms and preferably 2 to 6 carbon atoms, with polyfunctional carboxylic acids having 2 to 12 carbon atoms, examples being succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalenedicarboxylic acids.

The polyesterols used usually have a functionality of 1.5-4.

Particularly suitable are polyether polyols obtainable by known methods, for example by alkali-catalyzed or amine-catalyzed addition of ethylene oxide and propylene oxide onto H-functional starter molecules. The starter molecules used are low molecular weight alcohols or amines having a functionality of two or more.

Alkylene oxides used are usually ethylene oxide or propylene oxide, but also tetrahydrofuran, various butylene oxides, styrene oxide, preferably purely 1,2-propylene oxide. The alkylene oxides can be used singly, alternatingly in succession or as mixtures.

The starter substances used are more particularly compounds having at least 2 and preferably from 2 to 8 hydroxyl groups or having at least two primary amino groups in the molecule.

By way of starter substances having at least 2 and preferably from 2 to 8 hydroxyl groups in the molecule it is preferable to use trimethylolpropane, glycerol, pentaerythritol, sugar compounds such as, for example, glucose, sorbitol, mannitol and sucrose, polyhydric phenols, resols, for example oligomeric condensation products of phenol and formaldehyde and Mannich condensates of phenol, formaldehyde and dialkanolamines and also melamine.

By way of starter substances having at least two primary amino groups in the molecule it is preferable to use aromatic di- and/or polyamines, for example phenylenediamines, and 4,4′-, 2,4′- and 2,2′-diaminodiphenylmethane and also aliphatic di- and polyamines, such as ethylenediamine.

The polyether polyols have a functionality of preferably 2 to 8 and hydroxyl numbers of preferably 25 mg KOH/g to 2000 mg KOH/g and more particularly 150 mg KOH/g to 570 mg KOH/g.

The compounds having at least two isocyanate-reactive hydrogen atoms also include the optionally used chain extenders and crosslinkers. The addition of difunctional chain-extending agents, trifunctional and higher-functional crosslinking agents or else optionally mixtures thereof may prove advantageous for modifying the mechanical properties. Chain-extending and/or crosslinking agents used are preferably alkanolamines and more particularly diols and/or triols having molecular weights below 400 and preferably in the range from 60 to 300.

Chain-extending agents, crosslinking agents or mixtures thereof are advantageously used in an amount of 1% to 20% by weight and preferably 2% to 5% by weight, based on the polyol component.

The polyurethane or polyisocyanurate foams typically comprise flame retardants. It is preferable to use bromine-free flame retardants. Particular preference is given to flame retardants comprising phosphorus atoms, in that trichloroisopropyl phosphate, diethyl ethanephosphonate, triethyl phosphate and/or diphenyl cresyl phosphate are used in particular.

Catalysts used are particularly compounds which greatly speed the reaction of the isocyanate groups with the groups reactive therewith. Examples of such catalysts are basic amines, such as secondary aliphatic amines, imidazoles, amidines, alkanolamines, Lewis acids or organometallic compounds, particularly those based on tin. Catalyst systems, consisting of a mixture of various catalysts, can also be used.

Special catalysts are needed to incorporate isocyanurate groups in the rigid foam. The isocyanurate catalysts used are typically metal carboxylates, particularly potassium acetate and its solutions. The catalysts may, as required, be used alone or in any desired mixtures with each or one another.

Useful auxiliaries and/or added substances include the substances known per se for this purpose, examples being surface-active substances, foam stabilizers, cell regulators, fillers, pigments, dyes, antioxidants, hydrolysis control agents, antistats, fungistats and bacteriostats.

Further particulars concerning the starting materials, blowing agents, catalysts and also auxiliary and/or added substances used to carry out the process of the present invention are found for example in Kunststoffhandbuch, volume 7, “Polyurethane” Carl-Hanser-Verlag Munich, 1st edition, 1966, 2nd edition, 1983 and 3rd edition, 1993.

To produce isocyanate-based rigid foams, the polyisocyanates and the compounds having at least two isocyanate-reactive hydrogen atoms are reacted in such amounts that the isocyanate index is in a range between 100 and 220 and preferably between 105 and 180 in the case of the polyurethane foams. Mixing, as mentioned, typically takes place in a mixing head.

An exemplary embodiment of the present invention will now be more particularly described.

A mixing head in which the components are mixed with each other under elevated pressure (30-200 bar) in counter current was used to mix a polyol component and an isocyanate component and introduce the mixture into an open mold.

The polyol component consisted of a polyether alcohol, a polyester alcohol, emulsifiers, stabilizers, activators, catalysts and blowing agent. The catalyst used was Toyocat® TMF from Tosoh.

The blowing agent took the form of 1% by weight of water, 5% by weight of Enovate® 245 and 7% by weight, all based on the weight of the polyol component, of Solkane® 365/227(87:13) being included in the polyol component.

The isocyanate component used was polymeric MDI (Lupranat® M20 from BASF SE).

One experiment (a) was carried out without additional blowing agent. In another experiment (b) the blowing agent 134a was used. It was metered in an amount of 5% by weight, based on the weight of the polyol component, into the polyol feed line via a static mixer. An open-cell foam was obtained in experiment a and a closed-cell foam in experiment b.

Foam (a) was a substantially open-cell rigid foam having a density of 20 kg/m³. It had a DIN DIN EN 12667/Hesto thermal conductivity of 40 mW/m.K.

Foam (b) was a closed-cell rigid foam having a density of 50 kg/m3. It had a DIN EN 12667/Hesto thermal conductivity of 30 mW/m.K at 23° mid-point temperature.

When foam (b) was used, there was no significant pressure buildup during foaming. When used to foam-fill cavities in masonry, the use of foam (b) led to scarcely any egress through cracks in the masonry, whereas visible product egress was observed in the case of foam (a).

We claim:

1. A process for insulating a cavity in a built structure with a polyurethane rigid foam, by reaction of
a) polyisocyanates with
b) compounds having at least two isocyanate-reactive hydrogen atoms in the presence of
c) blowing agents, wherein the reaction takes place in the cavity to be insulated, wherein the blowing agent c) comprises at least one blowing agent ci) which only develops its blowing effect at the stage of the reaction of a) with b), and a blowing agent cii) which has a boiling point which is below the temperature at which the components a) and b) are mixed.

2. The process according to claim 1 wherein the blowing agent ci) is a chemical blowing agent.

3. The process according to claim 1 or 2 wherein the blowing agent ci) is water.

4. The process according to any one of claims 1 to 3 wherein the blowing agent ci) is a physical blowing agent.

5. The process according to claim 4 wherein the blowing agent ci) is selected from the group comprising hydrocarbons and halogenated hydrocarbons.

6. The process according to either claim 4 or 5 wherein the blowing agent cii) is at least one halogenated alkane.

7. The process according to any one of claims 1 to 6 wherein the blowing agent c) is a mixture of at least one physical and at least one chemical blowing agent.

8. The process according to any one of claims 1 to 7 wherein the blowing agent cii) is a physical blowing agent.

9. The process according to any one of claims 1 to 8 wherein the blowing agent cii) has a boiling point of below 0° C.

10. The process according to any one of claims 1 to 9 wherein the blowing agent cii) is admixed to the reaction mixture during the mixing of components a) and b).

11. The process according to any one of claims 1 to 10 wherein the blowing agent ci) is present before the mixing of components a) and b) in at least one of components a) and b).

12. A built structure comprising cavities in masonry having a polyurethane rigid foam present therein, wherein the polyurethane rigid foam is of the closed-cell type.

13. The built structure according to claim 12 wherein the polyurethane rigid foam was introduced into the cavities by a process according to any one of claims 1-11.
